(19) United States
(12) Patent Application Publication
(10) Pub. No.: US 2016/0379286 A1
(43) Pub. Date: Dec. 29, 2016

(54) Method and System of Obtaining a Bid For Services

(71) Applicant: Teligistics, Inc., Conroe, TX (US)

(72) Inventor: David T. Roberts, Conroe, TX (US)

(73) Assignee: Teligistics, Inc., Conroe, TX (US)

(21) Appl. No.: 15/263,622

(22) Filed: Sep. 13, 2016

Related U.S. Application Data
(62) Division of application No. 13/865,735, filed on Apr. 18, 2013.

(51) Int. Cl. G06Q 30/06

(52) U.S. Cl. CPC G06Q 30/0611

(57) ABSTRACT

A method and system of obtaining a bid from a provider of services, involving creating a client request for proposal (RFP) document, storing the client RFP document in a data store, inviting a bidding service provider to respond a stored client RFP document, allowing an invited bidding service provider to access the stored client RFP document, allowing the bidding service provider to respond to the stored client RFP document, obtaining all completed responses and all rate elements from bidding service providers, generating a comparative financial analysis showing a sorted list of responses, generating a weighted report, the generated weighted report comprising a display of bids having a best compliance with the client RFP document in top down order based on the comparative financial analysis, and providing the generated weighted report to the client.

### RELATIONSHIP TO OTHER APPLICATIONS

This application is a divisional of pending U.S. patent application Ser. No. 13/865,735, filed Apr. 18, 2013.

### BACKGROUND

Coordinating a request for proposal (“RFP”) to provide a service to a consumer of services, and coordinating responses to the RFP from a number of service providers, can be complicated and time consuming. Typically, the RFP process involves obtaining a response from each bidding service provider, such as but not limited to a telecommunications carrier, as to if and/or how they will comply with the requirements outlined in the RFP document. It can be helpful to have these responses generated as part of an auction or reverse auction process to arrive at the most competitive bid.

### DRAWINGS

The figures supplied herein disclose various embodiments of the claimed development.

FIG. 1 is a schematic illustration of an exemplary system;

FIG. 2 is an exemplary form illustrating aspects of a client RFP document;

FIG. 3 is an exemplary form illustrating aspects of client creation;

FIG. 4 is an exemplary form illustrating aspects of client creation;

FIG. 5 is an exemplary form illustrating further aspects of client RFP document creation and modification;

FIG. 6 is an exemplary form illustrating how a client RFP document is approved;

FIG. 7 is an exemplary form illustrating an invitation to a carrier to bid on an RFP;

FIG. 8 is an exemplary form illustrating a listing of those carriers invited to bid on an RFP;

FIG. 9 and FIG. 10 are exemplary forms illustrating aspects of carrier response forms;

FIG. 11 is an exemplary form illustrating further aspects of the client RFP document;

FIG. 12 is an exemplary form illustrating further aspects of carrier bid processes; and

FIG. 13 is an exemplary form illustrating a detail of a weighted report.

### DETAILED DESCRIPTION OF EXEMPLARY EMBODIMENTS

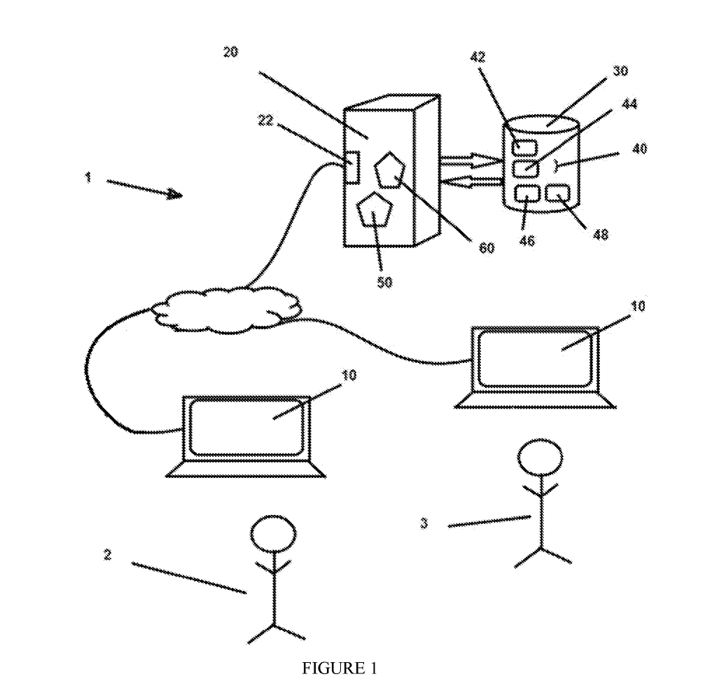

Referring now to FIG. 1, system 1 for processing a bid from a provider of services comprises web portal 10; computer 20 operatively in communication with web portal 10; data store 30 operatively in communication with computer 20; database 40 disposed on data store 30; database management software 50 operatively resident in computer 20, the database management software operative to manage database 40; and bid proposal software 60 operatively resident in computer 20, operatively accessible to user 2 and service provider 3 via web portal 10, and operatively in communication with database management software 50.

Web portal 10 is operatively, and in certain embodiments securely, accessible via a data network such as the Internet, typically via network interface 22 which is further accessible to computer 20. In a first embodiment, web portal 10 further comprises an ASP.NET component; a C# code behind component operatively in communication with the ASP.NET component; and an SQL database interface component, such as a Microsoft SQL Server database interface component, operatively in communication with the ASP.NET component or the C# code behind component, as these terms are familiar to those of ordinary skill in the programming arts. In a preferred embodiment, a predetermined number of data objects are also provided which comprise an AJAX component configured to communicate between client software processes and server software processes and a dual application programming interface (API) configured to be called from either a client or a server software process.

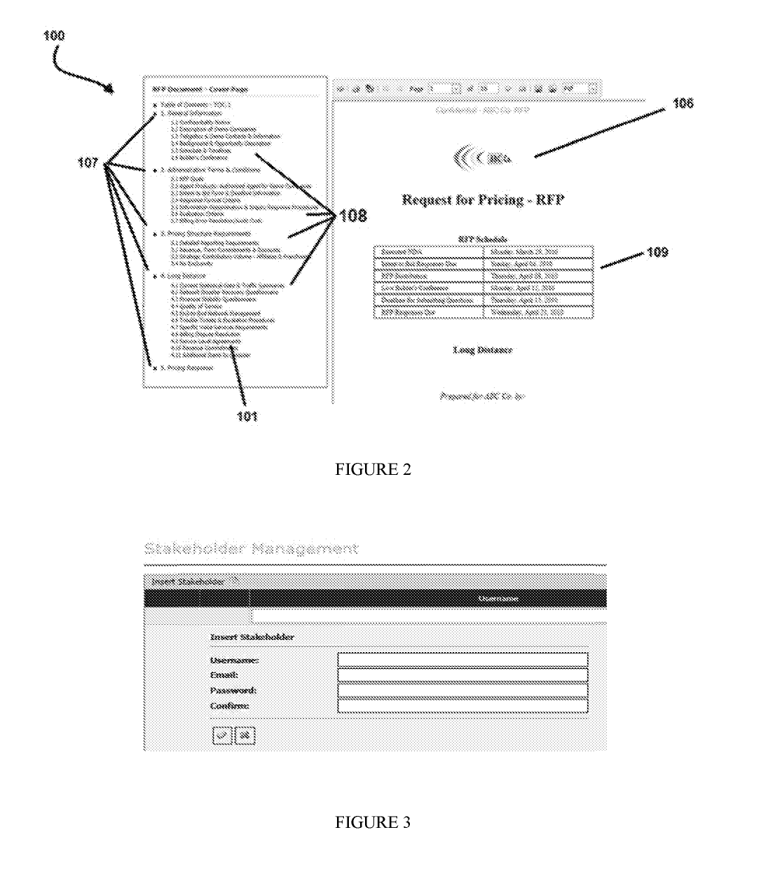

Database 40 typically comprises service provider table 42 comprising service provider data associated with service provider 3; request for proposal table 44 comprising request for proposal data associated with client 2; bid table 46 comprising service provider bid data associated with service provider 3, client 2, and a specific RFP, e.g. client RFP document 100 (FIG. 2); and request for proposal table 48 comprising RFP data such as may be reflected in client RFP document 100. These data are typically associated with, and/or obtained via, client RFP document 100 (FIG. 2).

Referring additionally now to FIG. 2, in typical embodiments client RFP document 100 comprises service description section 101, describing one or more services, such as but not limited to telecommunication (“telecom”) related services, that client 2 wishes to obtain from service provider 3; a set of specific requirements 102 (e.g., FIG. 10) associated with each service; textual description 103 of the service (e.g., FIG. 10); a predetermined set of individual rate elements 104 (not shown in the figures) of the service; and a predetermined set of associated current costs 105 (not shown in the figures) associated with the service. In further embodiments, client RFP document 100 may comprise a user or programmatically customizable client logo cover page 106; one or more document sections 107 (e.g., FIGS. 2 and 10) linked to client RFP document 100; one or more document subsections 108 (e.g., FIGS. 2 and 10) associated with document section 106; timeline 109, comprising an outline of a timeframe of all RFP items within a process for responding to client RFP document 100, where timeline 109 is linked to document section 106; and an image comprising a link to either document section 106 or document subsection 107. The image, if present, may be embedded during the generation of client RFP document 100 in a printable or exportable form of client RFP document 100.

Referring back to FIG. 1, bid proposal software 60 typically comprises template software 62 (not shown in the figures), bid software 64 (not shown in the figures), analysis software 66 (not shown in the figures), and response software 68 (not shown in the figures), each tailored to provide templates, bidding features, analysis features, and response features respectively, as further described below.

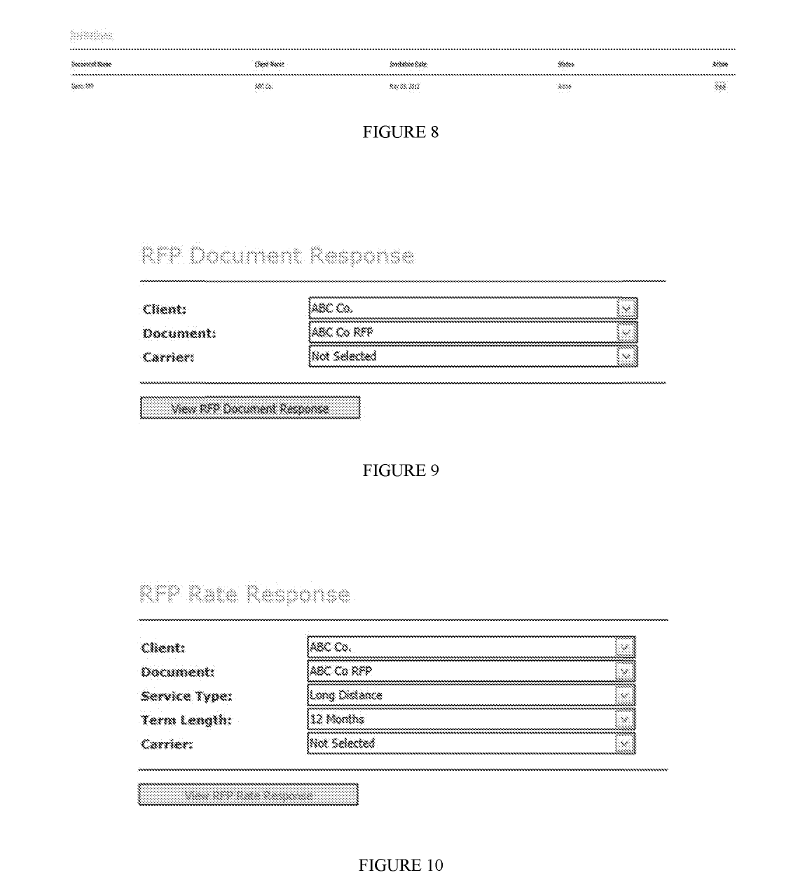

Template software 62 is typically configured to present a request for proposal form to client 2, obtain a desired set of services selected by client 2 using a request for proposal form such as illustrated in FIG. 8, and uniquely associate the selected desired set of services with client 2 in a unique record of request for proposal table 44.

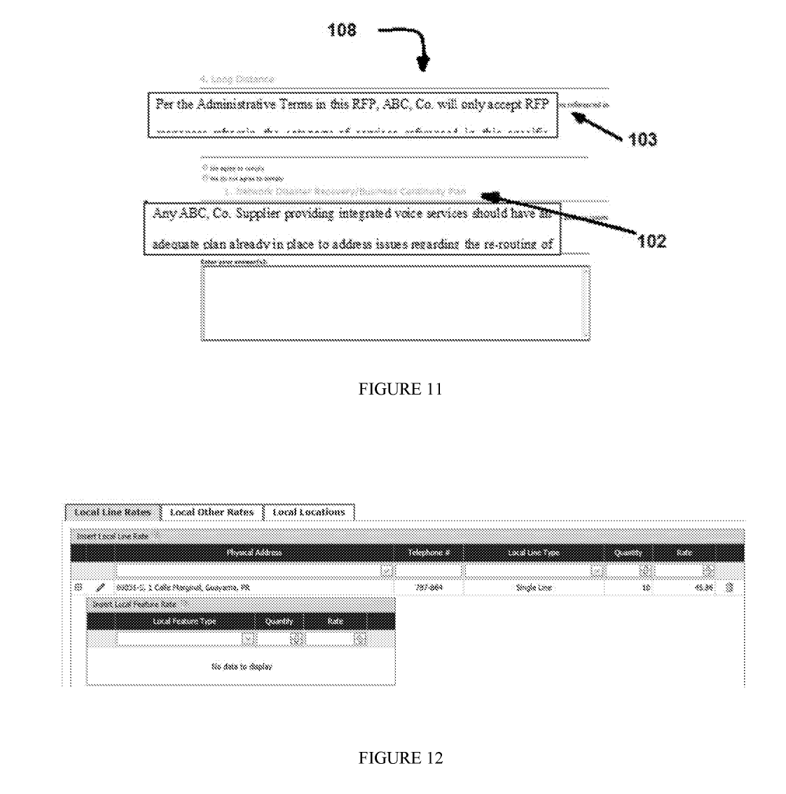

Bid software 64 is typically configured to present a bid form, such as illustrated in FIG. 11, to service provider 3, allow service provider 3 to bid on providing the desired set of services selected by client 2 using the bid form, and associate the bid with the unique record in request for proposal table 44.

Analysis software 66 is typically configured to compare bid data from one service provider 3 against bid data from each other service provider 3 for a specific, selected request for proposal record in request for proposal table 44 and generate a ranking for each such service provider 3 with respect to the specific request for proposal data associated with client 2.

Response software 68 is typically configured to present a rank ordered set of each such service provider 3 without allowing any service provider 3 to see any actual bid data from another service provider 3 while, at the same time, allowing client 2 to see actual bid data from each such service provider 3.

In the operation of exemplary embodiments, a bid from a provider of services, i.e. service provider 3 (FIG. 1), may be obtained by creating client RFP document 100 (FIG. 2) which is as described above. This can be via web portal 10 (FIG. 1) or any similar means, such as but not limited to paper forms or computer scannable forms or the like or a combination thereof. Such a bid will be for supplying one or more of the requirements and requests reflected in client RFP document 100 (FIG. 2), i.e. a conforming bid.

Service provider responses to requirements and requests reflected in client RFP document 100 (FIG. 2) are usually accomplished using web portal 10 (FIG. 1) by having each invited service provider 3 (FIG. 1) supply an answer to each required portion in client RFP document 100 when prompted to do so by a form on web portal 10. In some embodiments, service provider 3 may be allowed to import a client RFP document service provider rate response using a predefined import template corresponding to a specific service type. Additionally, an Administrative User (described below) may import a current cost for a specific service type by using a predefined rate import template corresponding to a specific service type.

Web portal 10 (FIG. 1) is usually configured to selectively allow access to client RFP document 100 (FIG. 2) to clients 2 (FIG. 1), who created a client RFP document 100, and service providers 3 (FIG. 1) who have been granted such access.

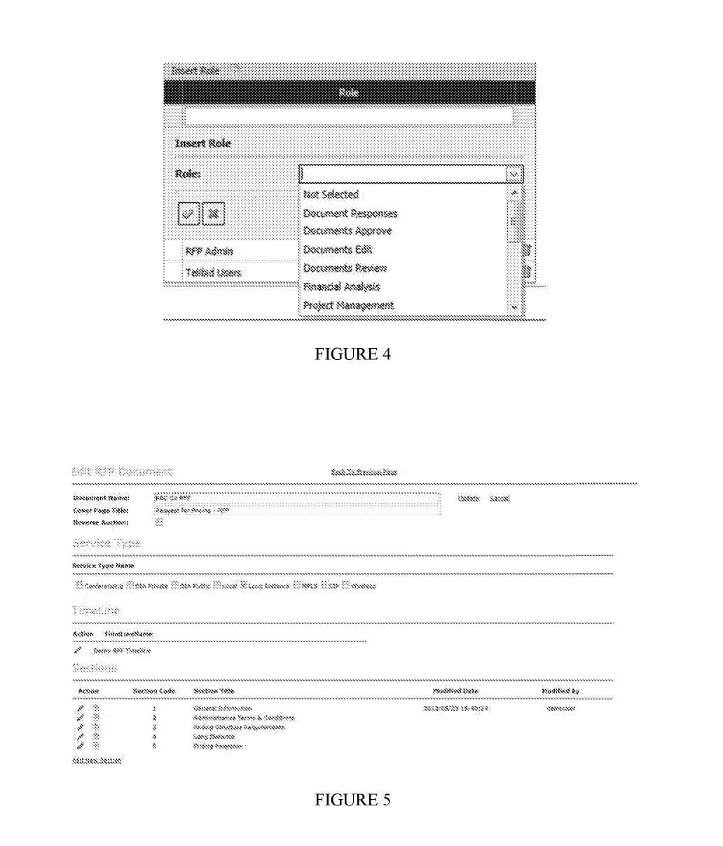

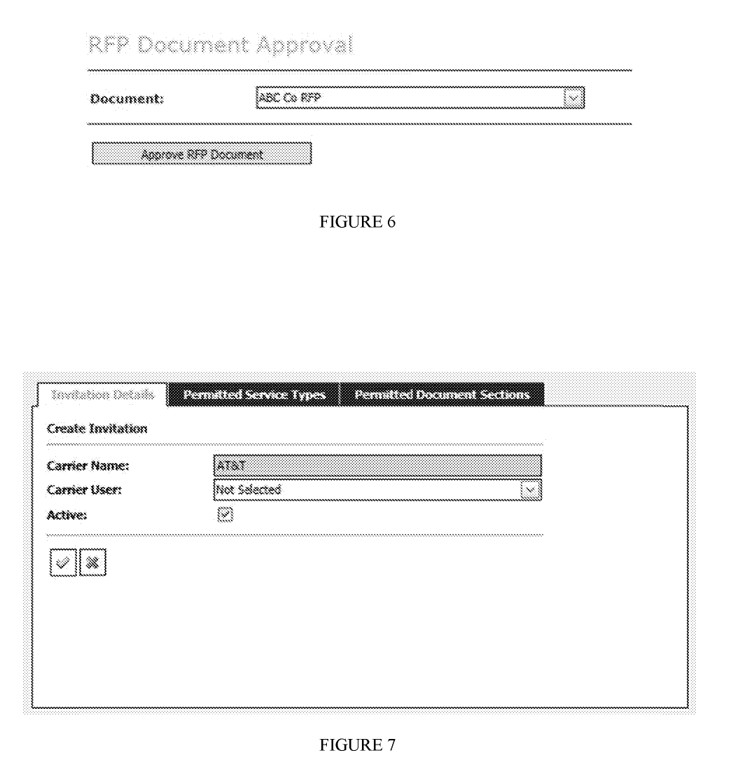

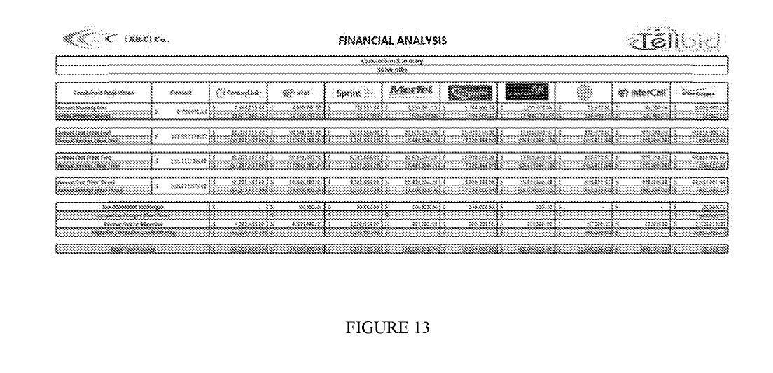

By way of example and not limitation, each user of web portal 10 is typically categorized such as an Administrative User, a Client User for client 2 (FIG. 1), a Service Provider User for service providers 3 (FIG. 1), or the like. Web portal 10 (FIG. 1) further typically comprises a set of user interface displays, generally described below, which implement and provide a user interface configured to provide a plurality of options to each user of web portal 10. Typically, the user interface selectively guides a user of web portal 10 in the steps needed to complete their required input into the RFP process. By way of further example and not limitation, web portal 10 may comprise or otherwise make various forms available such as browser-enabled or other Internet available forms, as illustrated in FIGS. 3-14. As illustrated in FIGS. 3-14, either an Administrative User or Client User with appropriate permissions can setup a Client User account (FIG. 3) and assign one or more roles/permissions to such a user (FIG. 4). Client Users can create and/or edit client RFP documents 100 (FIG. 2) and approve such client RFP documents 100 via one or more forms (FIGS. 5 and 6). Once submitted, Service Provider Users may be invited to view and respond to client RFP documents 100 via a form (FIG. 7). Client User and others may see a list of those Service Provider Users who have been invited, along with status information on their bidding, if any (FIG. 8). Client Users and/or Service Provider Users may retrieve (FIG. 9) client RFP documents 100 and modify various aspects of their response (e.g., FIG. 10). As illustrated in FIG. 10, Client Users can add descriptive or disclaiming qualifiers to portions of client RFP documents 100 (FIG. 11). Service Provider Users can use one or more forms (e.g., FIG. 12) to qualify and/or create a response to client RFP documents 100. Once bidding ceases, as described below, a weighted report (FIG. 13) may be generated and presented to client 2 such as on demand via web portal 10.

Client RFP document 100 (FIG. 2) may further comprise a client RFP document profile and a current spend by service types outline. In these embodiments, client RFP document 100 creation may further comprise adding a service type that is within a scope of client RFP document 100 to a client RFP document profile; creating a link between client RFP document 100 and a current spend by service types outline in client RFP document 100; and creating a link to client RFP document 100 and an entry placed on all service provider profiles that are invited to bid on that service type for a specific RFP embodied within client RFP document 100. For client RFP documents 100 that include document sections 107 (FIG. 2) and document subsections 108 (FIG. 2), these document sections 107 and document subsections 108 may be numbered and categorized each document section 107. For a plurality of invited service providers 3 (FIG. 1), a response from a first invited service provider 3 may be compared to each other response from each other invited service provider 3 using the numbered and categorized document section 107 and document subsection 108 for a document section 107 or document subsection 108 which requires a response.

Typically, each client 2 (FIG. 1) has an assigned account which comprises a username, password, and a profile. (See, e.g., FIGS. 3 and 4) Client 2 may be allowed access to a specific client profile and client RFP document 100 (FIG. 2) associated with the specific client profile. Additionally, service provider 3 (FIG. 1) may be allowed access to a specific service provider profile and to only those client RFP documents 100 for which they have an active invitation. The service provider active invitation usually comprises a set of permissions which selectively allow or disallow access to specific sections of client RFP document 100 to which a specific service provider 3 may respond as well as a definition of which service types on which they may place a bid.

Once obtained, client RFP document 100 (FIG. 2) may be stored in data store 30 (FIG. 1), which can be accessed by using web portal 10 (FIG. 1). Receipt and storage of client RFP document 100 may then trigger, such as by bid software 60 (FIG. 1), inviting one or more service providers 3 (FIG. 1) to be invited to respond to a stored client RFP document 100 by submitting a bid. To do so, each invited bidding service provider 3 may be allowed to access a stored client RFP document 100, typically during all of the duration of RFP timeline 109 (FIG. 2) embodied within client RFP document 100, and further allowed to respond to a stored client RFP document 100 by submitting an indication of the specific requirements with which service provider 3 will comply. Typically, for each specific requirement with which service provider 3 will comply, service provide 3 supplies an indication of how they will comply with each specific requirement; a textual response, if needed, such as to further clarify their response; and the actual bid for services from service provide 3 which represents the financial aspect of services they wish to provide to the client.

At a first predetermined time, bid software 60 (FIG. 1) obtains all completed responses and all rate elements from bidding service provider 3 (FIG. 1). At a second predetermined time, bid software 60 generates a comparative financial analysis showing a sorted list of responses. This analysis, typically by analysis software 66 (not shown in the figures), indicates savings over current costs 105 on a service provider by service provider basis and indicates savings over current costs 105 on a service type by service type basis, as illustrated in FIG. 13.

Generating the comparative financial analysis comprises generating a true monthly cost comparison for each service provider 3 (FIG. 1) that bids on a specific service type. In a first preferred embodiment for telecommunications services, a sum of the product of rate units/quantities multiplied by the rate per unit/quantity for all rate elements per service type is created for current costs and corresponding rate responses from each service provider 3 bidding on that service type. For telecommunication service providers, migration credits are subtracted and internal migration costs are added together. The internal migration costs are extrapolated out over a term of the commitment.

Client RFP document 100 (FIG. 2), as originally created, may be coupled with responses from service provider 3 (FIG. 1) to client RFP document 100 linked to each document section 107 (FIG. 2) and document subsection 108 (FIG. 2) that required a response and to which service provider 3 was invited to respond.

The financial analysis may further comprise comparing the total to be spent to the total bid from service provider 3 (FIG. 1) for each service type and service provider after all service provider responses have been received.

At a third predetermined time, bid software 60 (FIG. 1), e.g. response software 68 (not shown in the figures) and/or analysis software 66 (not shown in the figures), may generate a weighted report which comprises a display of bids having a best compliance with client RFP document 100 (FIG. 1) such as in a top down order based on the comparative financial analysis. This generated weighted report (FIG. 12) may then be presented to client 2 (FIG. 1) such as on demand via web portal 10 (FIG. 1).

In certain embodiments, an auction process may take place including selectively enabling or disabling a reverse auction by using an option on a client RFP document level during the duration of RFP timeline 109 (FIG. 2). The RFP timeline 109 may be embodied within client RFP document 100 (FIG. 2). For enabled reverse auctions, automatic updates of rankings of bids from an invited service provider 3 (FIG. 1) may be displayed, such as when service provider 3 submits a bid, including a display of rankings of each bid from each invited service provider 3 against each bid from each other invited service provider 3 and of each bid from each invited service provider 3 by their current rank in the bidding process.

Invited service provider 3 (FIG. 1) may further be allowed to run a document response report and/or a rate response report in real time on demand during the duration of an RFP timeline embodied within client RFP document 100 (FIG. 2). Client 2 (FIG. 1) may also be allowed to run a document response report and/or a rate response report in real time on demand at any time as their access permits.

In an alternative method, obtaining a bid from service provider 3 (FIG. 1) for providing a set of desired services to client 2 (FIG. 1) comprises obtaining a set of desired services from client 2, such as third-party telecom services; providing a first browser-based form that displays the set of desired services to a predetermined number of service providers 3 such as third-party telecom service providers; and obtaining a bid from a plurality of these service providers 3 to provide one or more of the set of desired services.

Once obtained, the bids obtained from each of the service providers 3 (FIG. 1) may be analyzed to generate a ranking for each such obtained set of bids, the ranking based on a predetermined set of ranking criteria. The analysis is typically performed by analysis software 68 (not shown in the figures) resident in computer 20 (FIG. 1) operatively in communication with the first browser-based form and may be triggered automatically by entry of one of the bids from one of service providers 3.

A first ranked listing display of the ranked bids may be generated and made available via a second browser-based form viewable by service providers 3 (FIG. 1), where the second browser-based form displays the ranking but not the actual bid data from service providers 3. A second ranked listing display may also be generated based on a predetermined set of ranking criteria and the actual bid data from the service providers 3. Client 2 (FIG. 1) may be allowed to view the second ranked listing display such as via a third browser-based form viewable by client 2, where the third browser-based form displays the ranking and the actual bid data from the providers of services.

In third embodiment, a bid from service provider 3 (FIG. 1) to provide a set of services to client 2 (FIG. 1) comprises obtaining login information from client 2, who is a consumer of services, and validating the login information. Upon validation, a predetermined portion of a browser-based form, viewable by client 2, is populated with a set of predefined service templates associated with client, e.g. by bid software 60 (FIG. 1). A set of allowable service types for client is displayed, such as via a first browser-based form and a set of desired service types obtained from client from the set of allowable service types. This set of desired service types may be associated with a request for services and the request for services associated with client 2 such as via client RFP document 100 (FIG. 2) which is stored in data store 30 (FIG. 1).

A predetermined set of service providers 3 (FIG. 1) may then be invited to bid on providing those service providers 3 with access to the set of desired service types, e.g. via access to client RFP document 100 (FIG. 2), and allowing each of the invited service providers 3 to submit a bid to provide the desired service types associated with the request. This provision may be by using a second browser-based form.

Upon receipt of each such bid, analysis software 68 (not shown in the figures) may be used to analyze the obtained set of bids and generate a ranking for each such obtained set of bids, where the ranking is based on a predetermined set of ranking criteria. The analysis may be performed either on demand, periodically, automatically, by being triggered by receipt of a change in a bid from service provider 3 (FIG. 1), or the like, or a combination thereof.

A ranked listing display of the ranked bids may be made available to client 2 (FIG. 1) via, e.g., a fourth browser-based form viewable by client 2 and invited service providers 3 (FIG. 1). Ranking is typically based on the total rates.

Invited service providers 3 (FIG. 1) may only see the ranking but not the actual bid data from the other service providers 3. However, client 2 (FIG. 1) may be allowed to view the ranking, such as via another browser-based form only viewable by client 2, based on a predetermined set of ranking criteria, and see the actual bid data from the service providers 3, as illustrated in FIG. 13. Client 2 may also be allowed to filter the bids by selecting one of the desired service types and, upon selection of the desired service type, populating a portion of the browser-based form with preview rate responses.

Where the template comprises a request for proposal, the template may be populated with information for a plurality of service types and, upon selection of the template by client 2 (FIG. 1), service providers 3 (FIG. 1) for each requested service type may be listed or otherwise displayed.

In any of these methods, service providers 3 may be allowed to adjust their bids during a predetermined period of time, e.g. an RFP timeline 109 (FIG. 2) embodied within client RFP document 100 (FIG. 2). Further, client 2 (FIG. 1) may be allowed to select one of the ranked bids, either at the conclusion of the process or at any time and, if client 2 does so, the service provider 3 that submitted that selected bid may be notified of the selection. In some embodiments, an advance agreement may be obtained from service provider 3 (FIG. 1), stating that making the bid constitutes a legally binding offer from service provider 3 and a corresponding advance agreement obtained from client 2 that selecting the bid by client 2 constitutes a legally binding acceptance of that offer. Optionally, service providers 3 who are not selected may be notified that they were not selected such as by electronic mail.

The foregoing disclosure and description of the inventions are illustrative and explanatory. Various changes in the size, shape, and materials, as well as in the details of the illustrative construction and/or an illustrative method may be made without departing from the spirit of the invention.

What is claimed is:

1. A system for providing a bid from a service provider to provide a service to a consumer, comprising:
a. a data store operatively accessible via the Internet;
b. a database disposed on the data store, the database comprising:
i. a service provider table populated with service provider data associated with a service provider;
ii. a request for proposal table populated with request for proposal data associated with a consumer; and
iii. a bid table populated with service provider bid data associated with the service provider, the consumer, and data in the request for proposal table;
c. a computer operatively in communication with the Internet and the data store;
d. proposal software resident in the computer and operatively accessible via the Internet, the proposal software operatively in communication with the database, the proposal software comprising:
i. template software configured to present a request for proposal form to a consumer in a consumer viewable medium, obtain a consumer selected desired set of services using the request for proposal form, and associate the selected desired set of services with the consumer in a unique request for proposal record in the request for proposal table;
ii. bid software configured to present a bid form to the service provider in a service provider viewable medium, allow the service provider to bid on providing the consumer selected desired set of services via the bid form, and associate the selected desired set of services with the consumer and the request for proposal record in a unique request for proposal record in the request for proposal table;
iii. analysis software configured to compare each service provider's bid data against each other service provider's bid data for a selected request for proposal record in the request for proposal table and generate a ranking for each such service provider; and
iv. response software configured to present a rank ordered set of each service provider who submitted a bid without allowing any service provider to see any other service provider's actual bid data while allowing the consumer to see each such service provider's actual bid data.

2. The system of claim 1, wherein the service provider table and the request for proposal table are configured for use with telecom-related services.

3. The system of claim 1, wherein the response software further comprises:
a. a financial analysis report generator; and
b. a financial analysis report display generator configured to present a generated financial analysis report on a consumer viewable medium.
